(19) United States
(12) Patent Application Publication
(10) Pub. No.: US 2020/0180210 A1
(43) Pub. Date: Jun. 11, 2020

(54) TRANSPARENT ARTICLE

(71) Applicant: NIPPON ELECTRIC GLASS CO., LTD., Shiga (JP)

(72) Inventor: Toshiyuki Kajioka, Otsu-shi (JP)

(21) Appl. No.: 16/641,861

(22) PCT Filed: Aug. 30, 2018
(86) PCT No.: PCT/JP2018/032168

§ 371 Date: Feb. 25, 2020

(30) Foreign Application Priority Data
Aug. 30, 2017 (JP) 2017-165685

(51) Int. Cl. B29C 59/00; B32B 3/28; B32B 7/02; C03C 15/00; C03C 17/25; C03C 19/00; G02B 1/18

(52) U.S. Cl. CPC B29C 59/00; B32B 3/28; B32B 7/02; C03C 15/00; G02F 2201/38; C03C 19/00; G02B 1/18; C03C 2217/77; C03C 17/25

(57) ABSTRACT

A transparent article is disclosed that includes a transparent base material. A main surface of the transparent base material includes a rough surface portion that is roughened. The rough surface portion has a root mean square height Sq of 0.08 μm or less and a mean width RSm of roughness curve profile elements of 20 μm or less.

### TECHNICAL FIELD

The present invention relates to a transparent article including a transparent base material having a roughened main surface.

### BACKGROUND ART

Conventionally, the surface of a transparent article arranged on a display surface of a display device is roughened to provide additional functionality or characteristic to the surface. For example, the surface of a transparent article used for a display device having touch panel functionality may be roughened to allow for smooth swiping of a finger. Further, a transparent article disclosed in Patent Document 1 includes an antifouling film that is arranged on a main surface and has a surface shaped such that the surface roughness Sq (RMS surface roughness) is 0.25 μm or less and the mean width RSm of roughness curve profile elements is 40 μm or less to improve the durability of the antifouling film.

### PRIOR ART LITERATURE

### Patent Literature

Patent Document 1: Japanese Patent No. 5839134

### SUMMARY OF THE INVENTION

### Problem to be Solved by the Invention

When the surface of a transparent article arranged on a display surface of a display device is roughened to allow for, for example, smooth swiping of a finger, the resolution of images seen through the transparent article will be decreased. The resolution of display devices has increased over these recent years. This has increased the influence of decreases in the resolution resulting from the roughened surface.

The inventor of the present invention have found that when the surface of a transparent article is roughened so that a specific parameter related to the surface roughness is included in a specified range, smooth finger swiping will be allowed while limiting decreases in the resolution. The present invention is made in view of such circumstances, and one object of the present invention is to allow for smooth finger swiping while limiting decreases in the resolution.

### Means for Solving the Problem

A transparent article that solves the above problem includes a transparent base material. A main surface of the transparent base material includes a rough surface portion that is roughened. The rough surface portion has a root mean square height Sq of 0.08 μm or less and a mean width RSm of roughness curve profile elements of 20 μm or less.

In the above transparent article, it is preferred that the rough surface portion have a ratio of the root mean square height Sq and the mean width RSm of roughness curve profile elements (Sq/RSm) of 0.004 or less.

In the above transparent article, it is preferred that the mean width RSm of roughness curve profile elements of the rough surface portion be 15 μm or less.

### Effect of the Invention

The transparent article of the present invention allows for smooth finger swiping while limiting decreases in the resolution.

### BRIEF DESCRIPTION OF THE DRAWINGS

FIG. 1 is a schematic diagram of a transparent article.

FIG. 2 is a schematic diagram illustrating a method for measuring the DOI value.

FIG. 3 is a schematic diagram of a pattern mask.

### MODE FOR CARRYING OUT THE INVENTION

One embodiment of the present invention will now be described.

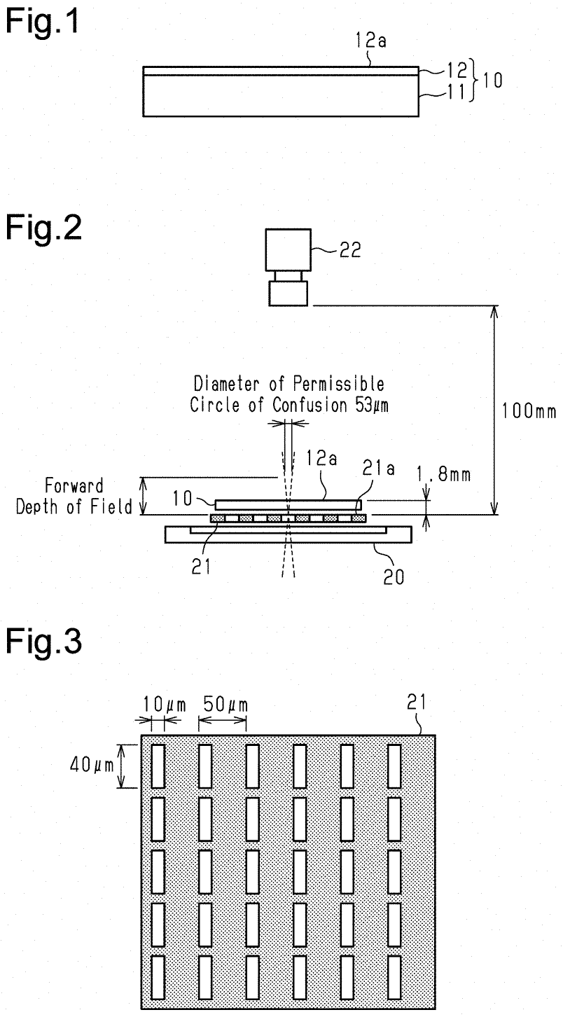

As shown in FIG. 1, a transparent article 10 includes a transparent base material 11 that is a light-transmissive panel. The transparent base material 11 has a thickness of, for example, 0.1 to 5 mm. The material for the transparent base material 11 is, for example, glass or resin. The material for the transparent base material 11 is preferably glass, and examples of the glass include known glass such as alkali-free glass, alumino-silicate glass, and soda lime glass. Further, reinforced glass such as chemically reinforced glass or crystallized glass such as LAS-type crystallized glass may be used. Preferably, alumino-silicate glass is used. Particularly, the use of chemically reinforced glass including 50% to 80% by mass of SiO₂, 5% to 25% by mass of Al₂O₃, 0% to 15% by mass of B₂O₃, 1% to 20% by mass of Na₂O, and 0% to 10% by mass of K₂O is preferred. The resin may be, for example, polymethylmethacrylate, polycarbonate, or epoxy resin.

One main surface of the transparent base material 11 is provided with a rough surface layer 12 that includes an uneven surface 12a. The rough surface layer 12 serves as a rough surface portion. The rough surface layer 12 is formed from, for example, a matrix containing an inorganic oxide, such as SiO₂, Al₂O₃, ZrO₂, or TiO₂. Preferably, the rough surface layer 12 is formed only from an inorganic oxide or inorganic oxides or does not include an organic compound.

The rough surface layer 12 may be formed by applying a coating agent to the surface of the transparent base material 11 and heating the coating agent. The coating agent includes, for example, a matrix precursor and a liquid medium that dissolves the matrix precursor. Examples of the matrix precursor in the coating agent include an inorganic precursor, such as a silica precursor, an alumina precursor, a zirconia precursor, or a Mania precursor. A silica precursor is preferred because it decreases the refractive index of the rough surface layer 12 and facilitates control of the reactivity.

Examples of the silica precursor includes a silane compound including a hydrocarbon group bound to a silicon atom and a hydrolyzable group, a hydrolytic condensate of a silane compound, and a silazane compound. It is preferred to include one of or both of a silane compound and a hydrolytic condensate thereof for adequately limiting formation of a crack in the rough surface layer 12 even when the rough surface layer 12 is formed to be relatively thick.

The silane compound includes a hydrocarbon group bound to a silicon atom and a hydrolyzable group. The hydrocarbon group may include a group selected from or a combination of two or more of —O—, —S—, —CO—, and —NR′— (R′ is a hydrogen atom or univalent hydrocarbon group) between carbon atoms.

The hydrocarbon group may be a univalent hydrocarbon group bound to one silicon atom or a divalent hydrocarbon group bound to two silicon atoms. Examples of the univalent hydrocarbon group include an alkyl group, an alkenyl group, and an aryl group. Examples of the divalent hydrocarbon group include an alkylene group, an alkenylene group, and an arylene group.

Examples of the hydrolyzable group include an alkoxy group, an acyloxy group, a ketoxime group, an alkenyloxy group, an amino group, an aminooxy group, an amido group, an isocyanate group, and a halogen atom. An alkoxy group, an isocyanate group, and a halogen atom (particularly, a chlorine atom) are preferred since they are well-balanced in terms of stabilizing the silane compound and facilitating hydrolysis of the silane compound. The alkoxy group is preferably an alkoxy group with 1 to 3 carbons, and further preferably a methoxy group or an ethoxy group.

Examples of the silane compound include an alkoxysilane (such as tetramethoxysilane, tetraethoxysilane, or tetraisopropoxysilane), an alkoxysilane including an alkyl group (such as methyltrimethoxysilane or ethyltrimethoxysilane), an alkoxysilane including a vinyl group (such as vinyltrimethoxysilane or vinyltriethoxysilane), an alkoxysilane including an epoxy group (such as 2-(3, 4-epoxycyclohexyl) ethyltrimethoxysilane, 3-glycidoxypropyltrimethoxysilane, 3-glycidoxypropylmethyldiethoxysilane, or 3-glycidoxypropyltriethoxysilane), and an alkoxysilane including an acryloyloxy group (such as 3-acryloyloxypropyltrimethoxysilane). Among these silane compounds, the use of at least one of or both of an alkoxysilane and a hydrolytic condensate thereof is preferred, and the use of a hydrolytic condensate of an alkoxysilane is further preferred.

The silazane compound is a compound including bonded silicon and nitrogen (—SiN—). The silazane compound may be a low-molecular compound or a high-molecular compound (polymer having a predetermined repeating unit). Examples of a low-molecular silazane compound include hexamethyldisilazane, hexaphenyldisilazane, dimethylaminotrimethylsilane, trisilazane, cyclotrisilazane, and 1, 1, 3, 3, 5, 5-hexamethylcyclotrisilazane.

Examples of the alumina precursor include an aluminum alkoxide, a hydrolytic condensate thereof, a water-soluble aluminum salt, and an aluminum chelate. Examples of the zirconia precursor include a zirconium alkoxide and a hydrolytic condensate thereof. Examples of the titania precursor include a titanium alkoxide and a hydrolytic condensate thereof.

The liquid medium contained in the coating agent is a solvent selected in accordance with a type of the matrix precursor and dissolves the matrix precursor. Examples of the liquid medium include water, an alcohol, a ketone, an ether, a cellosolve, an ester, a glycol ether, a nitrogen-containing compound, and a sulfur-containing compound.

Examples of the alcohol include methanol, ethanol, isopropanol, butanol, and diacetone alcohol. Examples of the ketone include acetone, methyl ethyl ketone, and methyl isobutyl ketone. Examples of the ether include tetrahydrofuran and 1, 4-dioxane. Examples of the cellosolve include methyl cellosolve and ethyl cellosolve. Examples of the ester include methyl acetate and ethyl acetate. Examples of the glycol ether include ethylene glycol monoalkyl ether. Examples of the nitrogen-containing compound include N,N-dimethylacetamide, N,N-dimethylformamide, and N-methylpyrrolidone. Examples of the sulfur-containing compound include dimethyl sulfoxide. The liquid medium may be of a single type or a combination of two or more types.

The liquid medium preferably contains water, or in other words, is preferably water, or a liquid mixture of water and another liquid medium. The other liquid medium is preferably an alcohol, and particularly preferably, methanol, ethanol, isopropyl alcohol, or butanol.

Further, the coating agent may include an acid catalyst that prompts hydrolysis and condensation of the matrix precursor. The acid catalyst is a component that prompts hydrolysis and condensation of the matrix precursor to form the rough surface layer 12 promptly. The acid catalyst may be added for hydrolysis and condensation of a raw material (such as alkoxysilane) during the preparation of a solution of the matrix precursor before the preparation of the coating agent, or, may be added after the preparation of essential components. Examples of the acid catalyst include an inorganic acid (such as nitric acid, sulfuric acid, or hydrochloric acid) and an organic acid (such as formic acid, oxalic acid, acetic acid, monochloroacetic acid, dichloroacetic acid, or trichloroacetic acid).

Examples of a method for applying the coating agent include a known wet coating process (such as spray coating, spin coating, dip coating, dye coating, curtain coating, screen coating, inkjet coating, flow coating, gravure coating, bar coating, flexo coating, slit coating, or roll coating). The spray coating facilitates the formation of the unevenness and is thus the preferred coating process.

Examples of a nozzle used for the spray coating include a twin-fluid nozzle and a single fluid nozzle. A droplet of the coating agent discharged from the nozzle normally has a diameter of 0.1 to 100 μm and preferably 1 to 50 μm. The diameter of a droplet of the coating agent can be adjusted, for example, by changing the type of the nozzle, atomization air pressure, or amount of liquid. For example, with a twin-fluid nozzle, the droplet becomes smaller as the atomization air pressure increases, and the droplet becomes larger as the liquid amount increases. The diameter of the droplet corresponds to the Sauter mean diameter measured by a laser measurement instrument.

When applying the coating agent, a coating subject (for example, transparent base material 11) has a surface temperature of, for example, 20° C. to 75° C., preferably 30° C. or greater, and further preferably 60° C. or greater. It is preferred that a hydronic heating device be used for heating the coating subject. Preferably, the humidity when applying the coating agent is, for example, 20% to 80%.

The surface shape of one main surface of the transparent base material 11 will now be described in detail.

One main surface of the transparent base material 11 is formed by the surface 12a of the rough surface layer 12. The surface 12a of the rough surface layer 12 has a surface shaped such that the root mean square height Sq is 0.08 μm or less and the mean width RSm of roughness curve profile elements is 20 μm or less. The surface shape that satisfies the above-described ranges allows for smooth finger swiping (smooth swiping touch) on the surface 12a and limits decreases in the resolution.

The root mean square height Sq is a value measured in accordance with ISO 25178, and the mean width RSm of roughness curve profile elements is a value measured in accordance with JIS B 0601 (2001). JIS B 0601 corresponds to ISO 4287 and is directed to the same technical content. Hereinafter, “root mean square height Sq” may simply be referred to as “height Sq” and “mean width RSm of roughness curve profile elements” may simply be referred to as “mean width RSm”.

The height Sq of the surface 12a of the rough surface layer 12 is 0.08 μm or less, and preferably 0.06 μm or less. Further, it is preferred that the surface 12a of the rough surface layer 12 have the height Sq of 0.02 μm or greater.

The mean width RSm of the surface 12a of the rough surface layer 12 is 20 μm or less, and preferably 15 μm or less. When the mean width RSm is 15 μm or less, finger swiping will be even more smooth. Further, it is preferred that the surface 12a of the rough surface layer 12 have the mean width RSm of 5 μm or greater.

Preferably, a ratio of the height Sq and the mean width RSm (Sq/RSm) of the surface 12a of the rough surface layer 12 is 0.004 or less. This further limits decreases in the resolution. The ratio of the height Sq and the mean width RSm (Sq/RSm) of the surface 12a of the rough surface layer 12 is further preferably 0.001 or greater.

The surface shape of the surface 12a of the rough surface layer 12 can be controlled by changing a formation condition of the rough surface layer 12. For example, in a case where the rough surface layer 12 is formed by the spray coating process, when the amount of the coating agent applied is decreased, the height Sq is decreased. The mean width RSm can be decreased by lowering the humidity when applying the coating agent or by reducing the diameter of spray droplets.

The rough surface layer 12, which includes the surface 12a shaped such that the height Sq is 0.08 μm or less and the mean width RSm is 20 μm or less, is easily formed particularly under a formation condition that quickly dries the droplets of the applied coating agent such as when the surface temperature of the transparent base material 11 is increased or the humidity is decreased during application of the coating agent.

The transparent article 10 formed as described above is, for example, arranged and used on a display surface of a display device designed to be touched by a finger, such as a display device having touch panel functionality. In this case, the transparent article 10 may be a member mounted on the display surface of the display device. That is, the transparent article 10 may be retrofitted to the display device. Preferably, the transparent article 10 is applied to a display device having a pixel density of 160 to 600 ppi.

The present embodiment has the following advantages.

(1) The transparent article 10 includes the transparent base material 11. The main surface of the transparent base material 11 is provided with the rough surface layer 12, which is roughened and serves as a rough surface portion. The height Sq of the surface 12a of the rough surface layer 12 is 0.08 μm or less and the mean width RSm of the surface 12a of the rough surface layer 12 is 20 μm or less.

The above structure allows for smooth finger swiping (smooth swiping touch) and limits decreases in the resolution.

(2) Preferably, the ratio of the height Sq and the mean width RSm (Sq/RSm) of the surface 12a of the rough surface layer 12 is 0.004 or less.

The above-described structure further limits decreases in the resolution.

(3) Preferably, the mean width RSm of the surface 12a of the rough surface layer 12 is 15 μm or less.

The above-described structure allows for further smooth finger swiping.

(4) Preferably, the ratio of the height Sq and the mean width RSm (Sq/RSm) of the surface 12a of the rough surface layer 12 is 0.004 or less and the mean width RSm is 15 μm or less.

The above-described structure has marked effects of both limiting decreases in the resolution and allowing for smooth finger swiping.

The present embodiment may be modified as described below.
The rough surface layer 12 may be multi-layered as long as it is shaped such that the height Sq and the mean width RSm of the surface 12a are in the above-described specified range. For example, the rough surface layer 12 may be formed by a first layer having an uneven surface and a second layer arranged on the first layer along the uneven surface of the first layer. Alternately, the rough surface layer 12 may be formed by a first layer that does not have an uneven surface and a second layer that has an uneven surface and is arranged on the first layer. In a case where the rough surface layer 12 is multi-layered, the surface of the outmost layer will be the surface 12a.
The rough surface layer 12 may also serve as a layer having a predetermined functionality. Examples of the functional layer include an anti-glare layer, an antireflection layer, and an antifouling layer. In a case where the rough surface layer 12 is multi-layered, each layer may have different functions. For example, the rough surface layer 12 may be formed by an anti-glare layer and an antireflection layer, which are sequentially arranged on the transparent base material 11.
In the above embodiment, the rough surface layer 12 arranged on the main surface of the transparent base material 11 serves as a rough surface portion. However, the structure of the rough surface portion is not limited to the rough surface layer 12. For example, the rough surface portion may be an uneven surface portion formed by performing a blasting process or an etching process on the surface of the transparent base material 11. The rough surface portion may further include the rough surface layer 12 arranged on the corrugated surface portion.
The rough surface portion may be arranged on the entire main surface of the transparent base material 11 or may be arranged on part of the main surface.

Technical concepts that can be understood from the above embodiment and the modified examples will now be described.

(a) The transparent article, in which the rough surface portion is a rough surface layer arranged on a main surface of the transparent base material.

(b) The transparent article, in which the rough surface layer is a layer containing at least one selected from SiO₂, Al₂O₃, ZrO₂, and TiO₂.

### EXAMPLES

The above embodiment will now be described in further detail with reference to experimental examples. The present invention is not limited to these experimental examples.

### Experimental Examples 1 to 16

Experimental examples 1 to 16 of the transparent article each including a rough surface layer on a main surface of the transparent base material with the rough surface layer shaped differently were produced.

In experimental examples 1 to 14, a coating agent was applied with a spray coating apparatus to one surface of the transparent base material (T2X-1, manufactured by Nippon Electric Glass Co., Ltd.), which was formed of a chemically reinforced glass panel having a thickness of 1.3 mm, to form the rough surface layer. The spray coating apparatus had a twin-fluid nozzle. The coating agent was a solution prepared by dissolving a precursor of the rough surface layer (tetraethyl orthosilicate) in a liquid medium including water. The coating agent was applied to the transparent base material with an atomization air pressure of 0.2 MPa at a flow rate of 0.3 kg per hour. Then, the transparent base material was heated at 180° C. for thirty minutes and dried.

In experimental examples 15 and 16, the rough surface layer (anti-glare layer) was formed on the transparent base material in the same manner as in experimental examples 1 to 14. Then, an antireflection layer was formed on the rough surface layer through reactive sputtering. The antireflection layer was a dielectric multilayer film including four layers, namely, a high refractive index film (niobium oxide, thickness of 15 nm), a low refractive index film (silicon oxide, thickness of 30 nm), a high refractive index film (niobium oxide, thickness of 110 nm), and a low refractive index film (silicon oxide, thickness of 80 nm) in this order from the side of the transparent base material.

As shown in Table 1, the surface shapes of the rough surface layer of the transparent article of experimental examples 1 to 16 were varied by changing the nozzle diameter of the twin-fluid nozzle, the atmospheric humidity around the transparent base material, the surface temperature of the transparent base material, and the amount of the coating agent applied per unit area when forming the rough surface layer.

### Experimental Example 17

In experimental example 1e 17, an antireflection layer was formed on one surface of the transparent material (T2X-1 manufactured by Nippon Electric Glass Co., Ltd.), which was formed of a chemically reinforced glass panel having a thickness of 1.3 mm, through reactive sputtering. The antireflection layer was a dielectric multilayer film including four layers, namely, a high refractive index film (niobium oxide, thickness of 15 nm), a low refractive index film (silicon oxide, thickness of 30 nm), a high refractive index film (niobium oxide, thickness of 110 nm), and a low refractive index film (silicon oxide, thickness of 80 nm) in this order from the side of the transparent base material. In this manner, the transparent article that did not have the rough surface layer was prepared.

TABLE 1

| | Nozzle | Atmospheric | Surface | Coating Agent |
|---|---|---|---|---|
| | Diameter | Humidity | Temperature | Amount |
| | (mm) | (%) | (° C.) | (g/m²) |
| Experimental | 0.6 | 54 | 20 | 22 |
| Example 1 | | | | |
| Experimental | 0.6 | 54 | 20 | 16 |
| Example 2 | | | | |
| Experimental | 0.6 | 54 | 20 | 13 |
| Example 3 | | | | |
| Experimental | 0.6 | 54 | 20 | 33 |
| Example 4 | | | | |
| Experimental | 0.6 | 67 | 20 | 33 |
| Example 5 | | | | |
| Experimental | 0.6 | 67 | 20 | 66 |
| Example 6 | | | | |
| Experimental | 0.6 | 48 | 20 | 22 |
| Example 7 | | | | |
| Experimental | 0.6 | 48 | 20 | 13 |
| Example 8 | | | | |
| Experimental | 0.6 | 48 | 20 | 16 |
| Example 9 | | | | |
| Experimental | 0.6 | 48 | 20 | 33 |
| Example 10 | | | | |
| Experimental | 0.4 | 52 | 20 | 31 |
| Example 11 | | | | |
| Experimental | 0.4 | 52 | 70 | 31 |
| Example 12 | | | | |
| Experimental | 0.6 | 54 | 20 | 27 |
| Example 13 | | | | |
| Experimental | 0.4 | 52 | 70 | 52 |
| Example 14 | | | | |
| Experimental | 0.6 | 52 | 20 | 16 |
| Example 15 | | | | |
| Experimental | 0.6 | 52 | 20 | 46 |
| Example 16 | | | | |
| Experimental | — | — | — | 0 |
| Example 17 | | | | |

Analysis of Surface Shape of Rough Surface Layer

The surface shape of the rough surface layer was measured using a scanning white-light interference microscope (VertScan, manufactured by Ryoka Systems Inc.). The measurement was performed over a measurement area of 316.77 μm×237.72 μm in WAVE mode using a 530 white filter and an objective lens with a magnifying power of 20 times at a resolution of 640 pixels×480 pixels. The measured roughness data underwent a primary surface correction using analysis software VS-Viewer to obtain the root mean square height Sq of each experimental example. The mean width RSm of roughness curve profile elements of each experimental example is a mean value of the RSM of each of ten lines that are parallel to the long-side of the measurement range and arranged from one end to the other end of the measurement range. Further, the ratio of the mean width RSm and the height Sq (Sq/RSm) was measured from measured values of the height Sq and the mean width RSm. The results are shown in Table 2. Before measuring the surface shape of the transparent article of each of experimental examples 15 to 17 with the scanning white-light interference microscope, a gold thin film was formed on the surface of the antireflection layer of each transparent article through sputtering to increase the optical reflectivity of the surface. As long as the gold thin film arranged on the antireflection layer has a thickness of approximately a few nanometers, the gold thin film directly traces the shape of the underlying unevenness. Thus, the effects on the measurement values of the height Sq and the mean width RSm can be ignored.

Evaluation of Finger Swiping

Ten panelists performed an operation of rubbing the surface of the rough surface layer of the transparent article of each experimental example with a finger cleaned with ethanol to evaluate whether good finger swiping (smooth swiping touch) was perceived. The results are shown in the column of “Finger Swiping” in Table 2. In the column of “Finger Swiping”, “∘∘”” indicates that eight or more people perceived good finger swiping, “∘” indicates that five or more and seven or less people perceived good finger swiping, and “x” indicates that less than four people perceived good finger swiping.

Evaluation of Resolution

As shown in FIG. 2, a pattern mask 21 was disposed on a planar light source 20, and the transparent article 10 was disposed on the pattern mask 21. In this case, the transparent article 10 was arranged so that the surface opposite to the surface 12a was faced toward the pattern mask 21. In addition, a light detector 22 was disposed at a position opposing the surface 12a of the transparent article 10. The light detector 22 was set to have a permissible circle of confusion with a diameter of 53 μm.

As shown in FIG. 3, the pattern mask 21 was a 500 ppi pattern mask having a pixel size of 10 μm×40 μm and a pixel pitch of 50 μm. The light detector 22 that was used was SMS-1000 (manufactured by Display-Messtechnik & Systeme).

The light detector 22 had a sensor size of ⅓ type and a pixel size of 3.75 μm×3.75 μm. The focal range of the light detector 22 was set to 100 mm, and the lens aperture diameter was set to 4.5 mm. The pattern mask 21 and the transparent article 10 were arranged so that the surface 12a of the transparent article 10 and a top surface 21a of the pattern mask 21 were included in the forward depth of field of the light detector 22 of which a permissible circle of confusion was set to 53 μm. Specifically, the pattern mask 21 was arranged so that the top surface 21a was located at the focal position of the light detector 22, and the transparent article 10 was arranged so that the distance between the top surface 21a of the pattern mask 21 and the surface 12a was 1.8 mm.

Then, in a state in which the planar light source 20 emitted light toward the transparent article 10 through the pattern mask 21, the light detector 22 captured an image of the transparent article 10 to obtain image data. The obtained image data was analyzed with the SMS-1000 in DOI measurement mode (software “Sparkle measurement system”) to calculate the pixel brightness of each pixel of the pattern mask 21. Then, a peak value (Ip) and a valley value (Iv) of the pixel brightness were calculated.

Further, the light detector 22 captured an image of the pattern mask 21 when the transparent article 10 was removed. The obtained image data was analyzed with the SMS-1000 in the DOI measurement mode to calculate the pixel brightness of each pixel of the pattern mask 21. Then, a peak value (Ip) and a valley value (Iv) of the pixel brightness were calculated.

The DOI value was calculated based on the following equation (1). The DOI value is a value that indicates a degree of decrease in resolution and becomes close to “1” as the decreases in resolution becomes smaller.

DOI value=[(Ip−Iv)/(Ip+Iv)]/[(Ip₀−Iv₀)/(Ip₀+Iv₀)] (1)

The DOI value of each experimental example is shown in the column of “Resolution” in Table 2. In the column of “Resolution”, the evaluation of DOI value is also shown with “∘∘” indicating DOI value of 0.86 or greater, “∘” indicating DOI value of 0.80 or greater and less than 0.86, and “x” indicating DOI value of less than 0.80.

TABLE 2

| | Surface Shape | | | Evaluation | | |
|---|---|---|---|---|---|---|
| | Sq | RSm | | Finger | | |
| | (μm) | (μm) | Sq/RSm | Swiping | Resolution | |
| Experimental | 0.049 | 16.5 | 0.002953 | ∘ | ∘∘ | (0.873) |
| Example 1 | | | | | | |
| Experimental | 0.038 | 16.1 | 0.002378 | ∘ | ∘∘ | (0.889) |
| Example 2 | | | | | | |
| Experimental | 0.033 | 16.4 | 0.002017 | ∘ | ∘∘ | (0.932) |
| Example 3 | | | | | | |
| Experimental | 0.073 | 14.3 | 0.005079 | ∘∘ | ∘ | (0.836) |
| Example 4 | | | | | | |
| Experimental | 0.032 | 23.8 | 0.001360 | x | ∘∘ | (0.943) |
| Example 5 | | | | | | |
| Experimental | 0.054 | 22.5 | 0.002395 | x | ∘∘ | (0.911) |
| Example 6 | | | | | | |
| Experimental | 0.061 | 13.4 | 0.004583 | ∘∘ | ∘ | (0.807) |
| Example 7 | | | | | | |
| Experimental | 0.042 | 13.7 | 0.003048 | ∘∘ | ∘∘ | (0.861) |
| Example 8 | | | | | | |
| Experimental | 0.045 | 13.6 | 0.003285 | ∘∘ | ∘∘ | (0.869) |
| Example 9 | | | | | | |
| Experimental | 0.089 | 13.6 | 0.006547 | ∘∘ | x | (0.772) |
| Example 10 | | | | | | |
| Experimental | 0.115 | 27.2 | 0.004228 | ∘∘ | x | (0.669) |
| Example 11 | | | | | | |
| Experimental | 0.025 | 12.1 | 0.002099 | ∘∘ | ∘∘ | (0.902) |
| Example 12 | | | | | | |
| Experimental | 0.065 | 16.1 | 0.004050 | ∘∘ | ∘ | (0.854) |
| Example 13 | | | | | | |
| Experimental | 0.047 | 14.5 | 0.003271 | ∘∘ | ∘∘ | (0.867) |
| Example 14 | | | | | | |
| Experimental | 0.042 | 14.5 | 0.002897 | ∘∘ | ∘∘ | (0.876) |
| Example 15 | | | | | | |
| Experimental | 0.098 | 14.9 | 0.006577 | ∘∘ | x | (0.740) |
| Example 16 | | | | | | |
| Experimental | <0.01 | — | — | x | ∘∘ | (0.914) |
| Example 17 | | | | | | |

As shown in Table 2, experimental examples 5, 6, 10, 11, and 16, in which the surface shape did not satisfy a first condition of “root mean square height Sq is 0.08 or less and mean width RSm of roughness curve profile elements is 20 μm or less”, were evaluated as having lower finger swiping smoothness or lower resolution than experimental examples 1 to 4, 7 to 9, and 12 to 15, in which the surface shape satisfied the first condition. This result indicates that a surface shape satisfying the first condition is effective for improving finger swiping smoothness while limiting decreases in the resolution.

Further, the results of experimental examples 1 to 3, 5, 6, 8, 9, 12, 14, and 15 indicate a tendency of decreases in the resolution to be further limited when the surface shape satisfies a second condition of “ratio of root mean square height Sq and mean width RSm of roughness curve profile elements (Sq/RSm) is 0.004 or less” in addition to the first condition. Moreover, the results of experimental examples 4, 7 to 9, 12, 14, and 15 indicate a tendency of finger swiping to be further improved when the surface shape satisfies a third condition of “mean width RSm of roughness curve profile elements is 15 μm or less” in addition to the first condition. In addition, the results of experimental examples 8, 9, 12, 14, and 15 indicate that a surface shape that satisfies the first condition, second condition, and third condition has marked effects of both limiting decreases in the resolution and allowing for smooth finger swiping.

Experimental example 17, in which no rough surface layer was provided, was evaluated as having lower finger swiping smoothness. This result indicates that having a rough surface layer is effective for improving finger swiping smoothness.

### DESCRIPTION OF REFERENCE CHARACTERS

10) transparent article, 11) transparent base material, 12) rough surface layer, 12a) surface.

1. A transparent article comprising a transparent base material, wherein
a main surface of the transparent base material includes a rough surface portion that is roughened, and
the rough surface portion has a root mean square height Sq of 0.08 μm or less and a mean width RSm of roughness curve profile elements of 20 μm or less.

2. The transparent article according to claim 1, wherein the rough surface portion has a ratio of the root mean square height Sq and the mean width RSm of roughness curve profile elements (Sq/RSm) of 0.004 or less.

3. The transparent article according to claim 1, wherein the mean width RSm of roughness curve profile elements of the rough surface portion is 15 μm or less.
